(19) United States
(12) Patent Application Publication
(10) Pub. No.: US 2021/0076032 A1
(43) Pub. Date: Mar. 11, 2021

(54) FILTER SHAPES FOR CROSS-COMPONENT ADAPTIVE LOOP FILTER WITH DIFFERENT CHROMA FORMATS IN VIDEO CODING

(71) Applicant: QUALCOMM Incorporated, San Diego, CA (US)

(72) Inventors: Nan Hu, San Diego, CA (US); Jie Dong, Sunnyvale, CA (US); Vadim Seregin, San Diego, CA (US); Marta Karczewicz, San Diego, CA (US)

(21) Appl. No.: 16/929,868

(22) Filed: Jul. 15, 2020

Related U.S. Application Data
(60) Provisional application No. 62/897,627, filed on Sep. 9, 2019.

(51) Int. Cl. H04N 19/117; H04N 19/132; H04N 19/159; H04N 19/186; H04N 19/172

(52) U.S. Cl. CPC H04N 19/117; H04N 19/132; H04N 19/172; H04N 19/186; H04N 19/159

(57) ABSTRACT

As part of a process to encode or decode video data, a video coding device determines a value by applying an adaptive loop filter (ALF) to luma samples corresponding to a chroma sample of a current picture, the luma samples corresponding to the chroma sample being within a filter pattern that is the same for all chroma formats and types of chroma samples. A center coefficient of the filter pattern is applied to a collocated luma sample of the chroma sample. The video coding device adds the value to the chroma sample to determine a modified chroma value.

This application claims the benefit of U.S. Patent Application 62/897,627, filed Sep. 9, 2019, the entire content of which is incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for applying a cross-component adaptive loop filter (CC-ALF) in video coding. CC-ALF is a technique in which a video coder (e.g., a video encoder or a video decoder) determines a value for a chroma sample by applying a filter to a set of luma samples. The video coder modifies the chroma sample by adding the determined value for the chroma sample to the chroma sample. CC-ALF may lead to better visual quality and/or improved coding efficiency. The techniques of this disclosure may improve CC-ALF by enabling CC-ALF to be used with multiple chroma formats and types of chroma samples without, in some examples, increasing storage requirements of the video coder.

In one example, this disclosure describes a method of coding video data, the method comprising: determining a value by applying an adaptive loop filter (ALF) to luma samples corresponding to a chroma sample of a current picture, the luma samples corresponding to the chroma sample being within a filter pattern that is the same for all chroma formats and types of chroma samples, wherein a center coefficient of the filter pattern is applied to a collocated luma sample of the chroma sample; and adding the value to the chroma sample to determine a modified chroma value.

In another example, this disclosure describes a device for coding video data, the device comprising: a memory configured to store the video data; and one or more processors implemented in circuitry, the one or more processors configured to: determine a value by applying an ALF to luma samples corresponding to a chroma sample of a current picture, the luma samples corresponding to the chroma sample being within a filter pattern that is the same for all chroma formats and types of chroma samples, wherein a center coefficient of the filter pattern is applied to a collocated luma sample of the chroma sample; and add the value to the chroma sample to determine a modified chroma value.

In another example, this disclosure describes a device for coding video data, the device comprising: means for determining a value by applying an adaptive loop filter (ALF) to luma samples corresponding to a chroma sample of a current picture, the luma samples corresponding to the chroma sample being within a filter pattern that is the same for all chroma formats and types of chroma samples, wherein a center coefficient of the filter pattern is applied to a collocated luma sample of the chroma sample; and means for adding the value to the chroma sample to determine a modified chroma value.

In another example, this disclosure describes a computer-readable storage medium having stored thereon instructions that, when executed, cause one or more processors to: determine a value by applying an adaptive loop filter (ALF) to luma samples corresponding to a chroma sample of a current picture, the luma samples corresponding to the chroma sample being within a filter pattern that is the same for all chroma formats and types of chroma samples, wherein a center coefficient of the filter pattern is applied to a collocated luma sample of the chroma sample; and add the value to the chroma sample to determine a modified chroma value.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a conceptual diagram illustrating example chroma sample location types for a 4:2:0 chroma format.

FIG. 5 is a conceptual diagram illustrating example chroma sample locations for a 4:2:2 chroma format.

FIG. 6 is a conceptual diagram illustrating example chroma sample locations for a 4:4:4 chroma format.

FIG. 7 is a conceptual diagram illustrating cross-component adaptive loop filtering.

FIG. 8 is a conceptual diagram illustrating an example filter pattern.

FIG. 9 is a conceptual diagram illustrating example diamond filter shapes in accordance with one or more techniques of this disclosure.

FIG. 10 is a flowchart illustrating an example method for encoding a current block of a current picture of video data in accordance with one or more techniques of this disclosure.

FIG. 11 is a flowchart illustrating an example method for decoding a current block of a current picture of video data in accordance with one or more techniques of this disclosure.

FIG. 12 is a flowchart illustrating an example method for coding a current block of video data, in accordance with one or more techniques of this disclosure.

### DETAILED DESCRIPTION

Cross-component adaptive loop filtering (CC-ALF) is a technique in which a video coder (e.g., a video encoder or a video decoder) refines chroma samples within pictures of video data. To apply CC-ALF, the video coder determines a value for a chroma sample by applying a filter to a set of luma samples. The video coder modifies the chroma sample by adding the determined value for the chroma sample to the chroma sample. CC-ALF may lead to better visual quality and/or improved coding efficiency.

Conventionally, CC-ALF has only been applied to pictures coded using the 4:2:0 chroma format with type 0 chroma samples. In the 4:2:0 chroma format with type 0 chroma samples, chroma samples are located at positions that are vertically between positions of luma samples, but not at the same positions as luma samples and not at other positions between luma samples. Accordingly, when applying CC-ALF, the filter applied to the set of luma samples has positions for luma samples above and below the position of the chroma sample.

However, in other chroma formats, such as the 4:2:2 and 4:4:4 chroma formats, there is a luma sample at the same position as the chroma sample. However, if a video coder were to use the conventional filter pattern, the filter would be unbalanced vertically or would not use the luma sample that is collocated with the chroma sample. Moreover, in the 4:2:0 chroma format, the conventional filter pattern may be misaligned when other chroma sample types are used. Using different filter patterns for different chroma formats and different chroma sample types may address this problem but may lead to increased storage requirements at the video coder (e.g., to store additional filter coefficients used in filters with different filter patterns.

The techniques of this disclosure may improve CC-ALF by enabling CC-ALF to be used with multiple chroma formats and types of chroma samples without, in some examples, increasing storage requirements of the video coder. For example, in accordance with one or more techniques of this disclosure, a video coder may determine a value by applying an ALF to luma samples corresponding to a chroma sample of a current picture. The luma samples corresponding to the chroma sample are within a filter pattern that is the same for all chroma formats and types of chroma samples. A center coefficient of the filter pattern is applied to a collocated luma sample of the chroma sample. Furthermore, the video coder may add the value to the chroma sample to determine a modified chroma value. In this way, the video coder may be able to determine a refined version of the chroma sample by applying CC-ALF in a way that is independent of the chroma format and chroma sample type and/or does not increase storage requirements of the video coder.

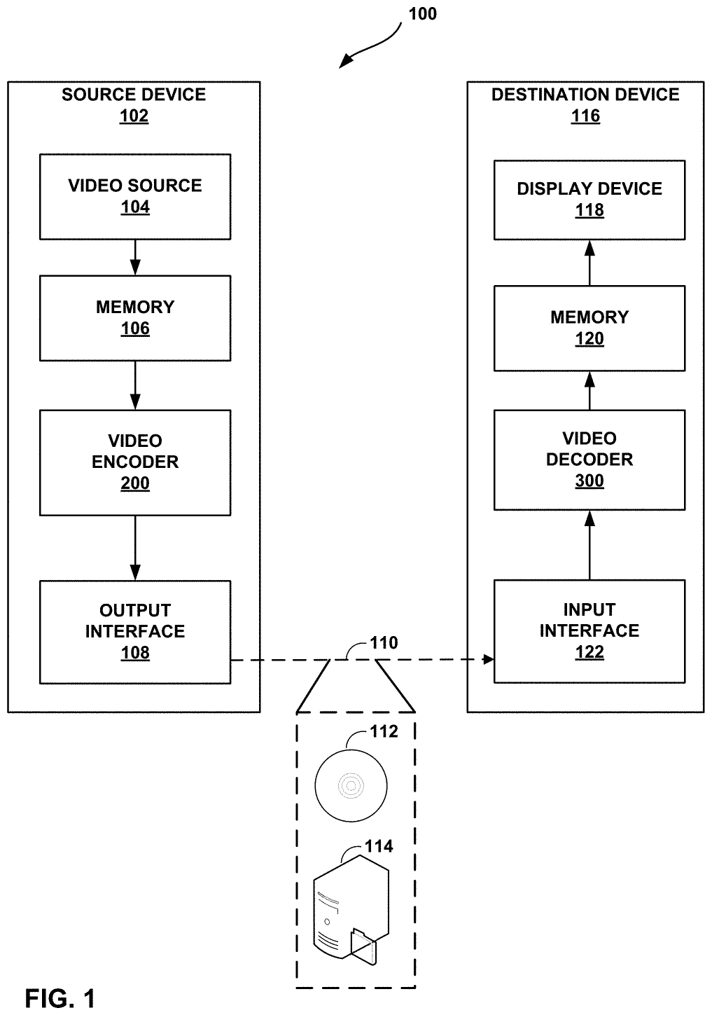

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, tablet computers, set-top boxes, mobile devices (e.g., telephone handsets such as smartphones), televisions, cameras, display devices, digital media players, video gaming consoles, video streaming devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for performing of cross-component adaptive filtering described in this disclosure. Source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for cross-component adaptive filtering described in this disclosure. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream that includes encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, computer-readable medium 110 includes storage devices 112. Source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, computer-readable medium 110 may include file server 114 or another intermediate storage device that may store the encoded video data generated by source device 102. Source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a cathode ray tube (CRT), a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). A recent draft of the VVC standard is described in Bross, et al. “Versatile Video Coding (Draft 6),” Joint Video Experts Team (JVET) of ITU-T SG 16 WP 3 and ISO/IEC JTC 1/SC 29/WG 11, 15^{th} Meeting: Gothenburg, SE, 3-12 Jul. 2019, JVET-O2001-vE (hereinafter “VVC Draft 6”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning a picture into CTUs and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

In accordance with the techniques of this disclosure, a video coder (e.g., video encoder 200 or video decoder 300) may determine a value by applying an ALF to luma samples corresponding to a chroma sample of a current picture. In such examples, the luma samples corresponding to the chroma sample are within a filter pattern that is the same for all chroma formats and types of chroma samples. Furthermore, in such examples, a center coefficient of the filter pattern is applied to a collocated luma sample of the chroma sample. The video coder may also be configured to add the value to the chroma sample to determine a modified chroma value. In this way, the video coder may be able to determine a refined version of the chroma sample by applying CC-ALF in a way that is independent of the chroma format and chroma sample type and/or does not increase storage requirements of the video coder.

In some examples, the video coder (e.g., video encoder 200 or video decoder 300) may determine a filter pattern from a plurality of filter patterns. The video coder may also be configured to determine a value by applying an ALF to luma samples corresponding to a chroma sample of a current picture, the luma samples corresponding to the chroma sample being within the determined filter pattern. In some such examples, a center coefficient of the filter pattern is applied to a collocated luma sample of the chroma sample. Additionally, the video coder may add the value to the chroma sample to determine a modified chroma value.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

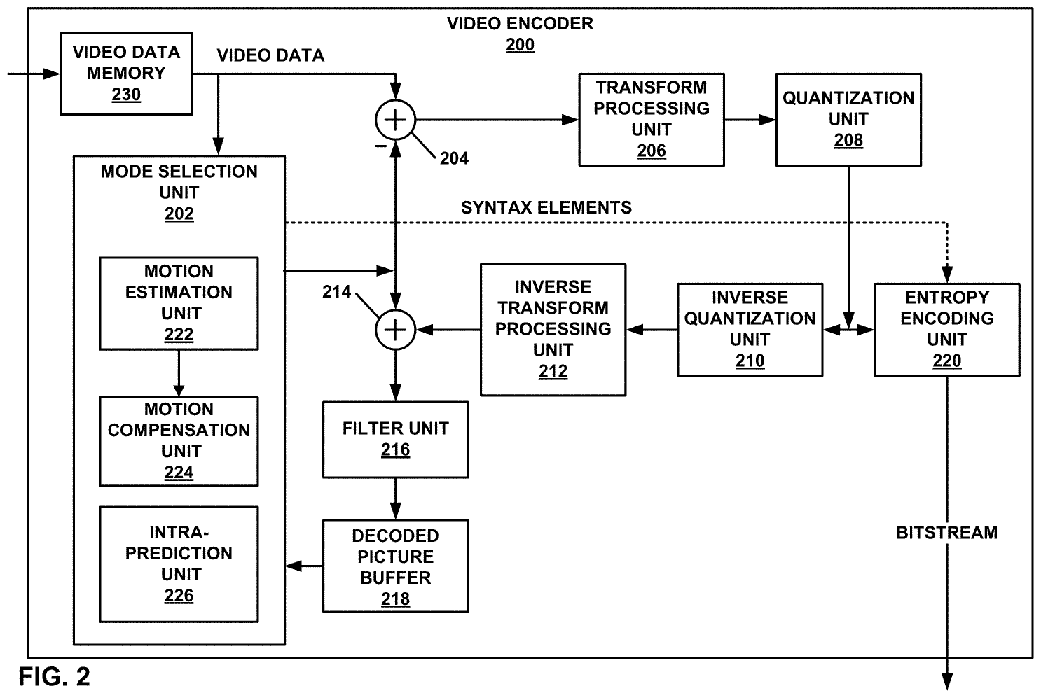

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 in the context of video coding standards such as the HEVC video coding standard and the H.266 video coding standard in development. However, the techniques of this disclosure are not limited to these video coding standards and are applicable generally to video encoding and decoding.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that define the positions of the reference blocks in the reference pictures relative to the position of the current block in a current picture. Motion estimation unit 222 may then provide the motion vectors to motion compensation unit 224. Motion compensation unit 224 may then generate a prediction block using the motion vectors.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nLx2N, and nRx2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as a few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. In some examples, filter unit 216 may apply CC-ALF. In some examples, as part of applying CC-ALF, filter unit 216 may determine a value by applying an ALF to luma samples corresponding to a chroma sample of a current picture. In such examples, the luma samples corresponding to the chroma sample are within a filter pattern that is the same for all chroma formats and types of chroma samples. Furthermore, in such examples, a center coefficient of the filter pattern is applied to a collocated luma sample of the chroma sample. Filter unit 216 may add the value to the chroma sample to determine a modified chroma value.

Video encoder 200 stores reconstructed blocks in DPB 218. For instance, reconstruction unit 214 may store reconstructed blocks to DPB 218. In examples where operations of filter unit 216 are needed, filter unit 216 may store the filtered reconstructed blocks to DPB 218. In some examples, DPB 218 may also store unfiltered and filtered versions of the same reconstructed blocks. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture. For instance, in some examples, intra-prediction unit 226 may use unfiltered versions of reconstructed blocks stored in DPB 218.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying an MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to determine a filter pattern from a plurality of filter patterns. The one or more processing units may also be configured to determine a value by applying an ALF to luma samples corresponding to a chroma sample of a current picture, the luma samples corresponding to the chroma sample being within the determined filter pattern. Additionally, the one or more processing units may be configured to add the value to the chroma sample to determine a modified chroma value.

In some examples, the one or more processing units of video encoder 200 may be configured to determine a value by applying an ALF to luma samples corresponding to a chroma sample of a current picture. In such examples, the luma samples corresponding to the chroma sample are within a filter pattern that is the same for all chroma formats and types of chroma samples. Furthermore, in such examples, a center coefficient of the filter pattern is applied to a collocated luma sample of the chroma sample. The one or more processing units may also be configured to add the value to the chroma sample to determine a modified chroma value.

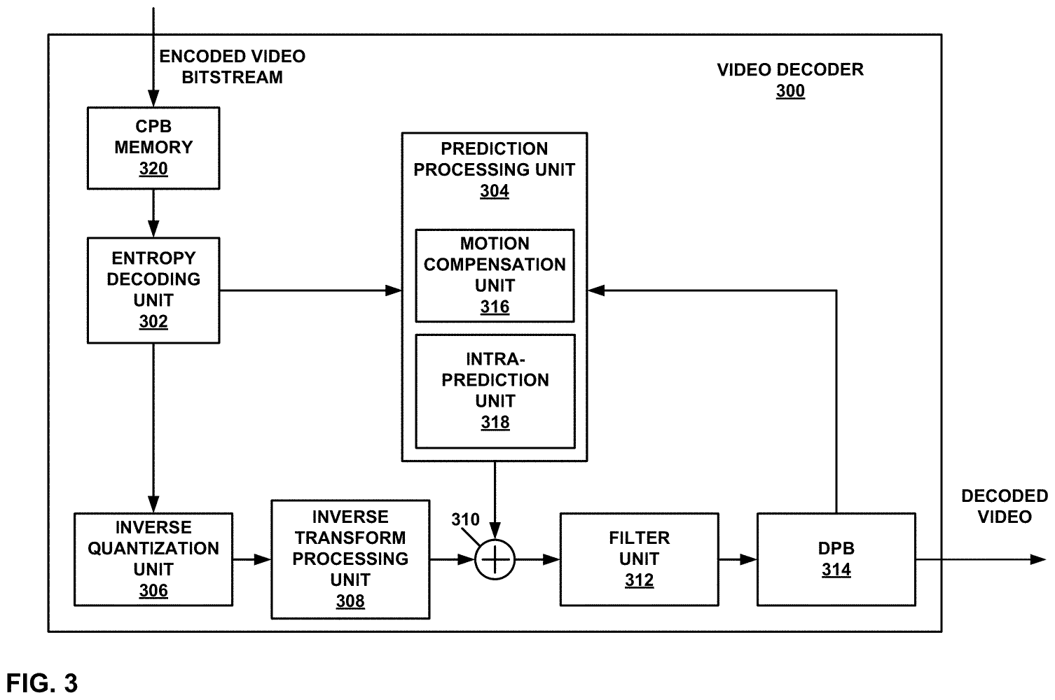

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. In some examples, filter unit 312 may apply CC-ALF. In some examples, as part of applying CC-ALF, filter unit 312 may determine a value by applying an ALF to luma samples corresponding to a chroma sample of a current picture. In such examples, the luma samples corresponding to the chroma sample are within a filter pattern that is the same for all chroma formats and types of chroma samples. Furthermore, in such examples, a center coefficient of the filter pattern is applied to a collocated luma sample of the chroma sample. Filter unit 312 may add the value to the chroma sample to determine a modified chroma value.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. In some examples, DPB 314 may store filtered and unfiltered versions of the same reconstructed blocks. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to determine a filter pattern from a plurality of filter patterns. The one or more processing units may also be configured to determine a value by applying an ALF to luma samples corresponding to a chroma sample of a current picture, the luma samples corresponding to the chroma sample being within the determined filter pattern. Additionally, the one or more processing units may be configured to add the value to the chroma sample to determine a modified chroma value.

In some examples, the one or more processing units of video decoder 300 may be configured to determine a value by applying an ALF to luma samples corresponding to a chroma sample of a current picture. In such examples, the luma samples corresponding to the chroma sample are within a filter pattern that is the same for all chroma formats and types of chroma samples. Furthermore, in such examples, a center coefficient of the filter pattern is applied to a collocated luma sample of the chroma sample. The one or more processing units may also be configured to add the value to the chroma sample to determine a modified chroma value.

Misra et al., “Cross-Component Adaptive Loop Filter for Chroma,” Joint Video Experts Team (WET) of ITU-T SG 16 WP 3 and ISO/IEC JTC 1/SC 29/WG 11, 15th Meeting: Gothenburg, SE, 3-12 Jul. 2019, document WET-O0636 (hereinafter, “WET-O0636”) describes a tool called cross-component adaptive loop filter (CC-ALF). CC-ALF operates as part of an adaptive loop filter (ALF) and makes used of luma samples to refine each chroma component. The CC-ALF tool is controlled by information in the bitstream, and this information includes filter coefficients for each chroma component (signaled in adaptation parameter set (APS)) and a mask controlling the application of the filter for blocks of samples.

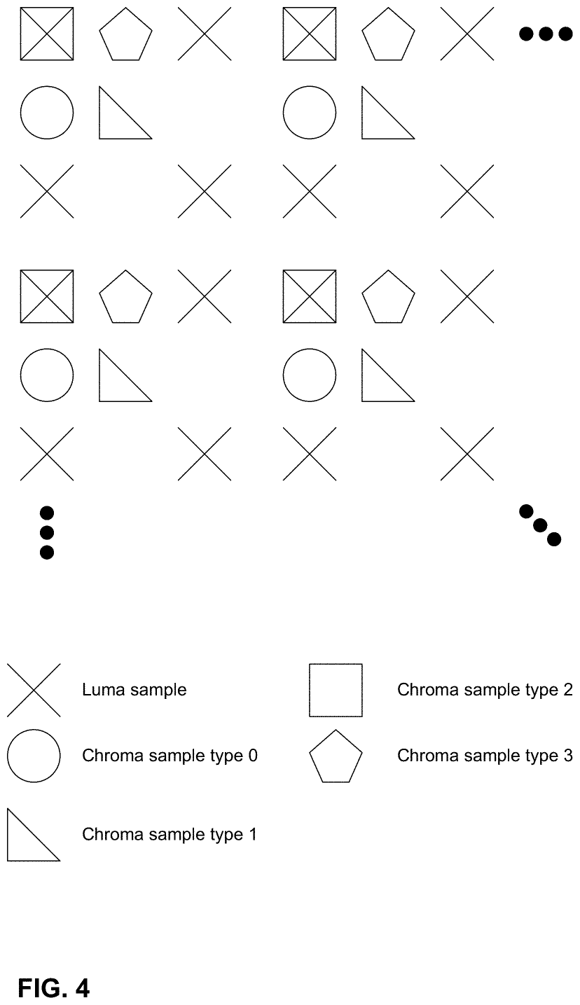

FIG. 4 is a conceptual diagram illustrating example chroma sample location types for a 4:2:0 chroma format. As shown in the example of FIG. 4, there may be four different types of chroma sample arrangements when a picture is encoded using the 4:2:0 chroma format. Specifically, in the example of FIG. 4, when a picture is encoded using the 4:2:0 chroma format and type 0 chroma samples (indicated using circles in FIG. 4), there are chroma samples in alternating rows and columns of luma sample locations and the chroma sample locations are midway vertically between luma sample locations. When a picture is encoded using the 4:2:0 chroma format and type 1 chroma samples, there are chroma samples for alternating rows and columns of luma sample locations and the chroma samples are midway vertically and horizontally between luma sample locations. When a picture is encoded using the 4:2:0 chroma format and type 2 chroma samples, there are chroma samples for alternating rows and columns of luma sample locations and the chroma samples are directly aligned with luma sample locations. When a picture is encoded using the 4:2:0 chroma format and type 3 chroma samples, there are chroma samples for alternating rows and columns of luma sample locations and the chroma samples are midway horizontally between luma sample locations. For type 0, 1, and 3 chroma samples, the luma sample that is above and/or left of the chroma sample is referred to as a collocated luma sample of the chroma sample. For type 2 chroma samples, the luma sample that is in the same location as the chroma sample is the collocated luma sample of the chroma sample.

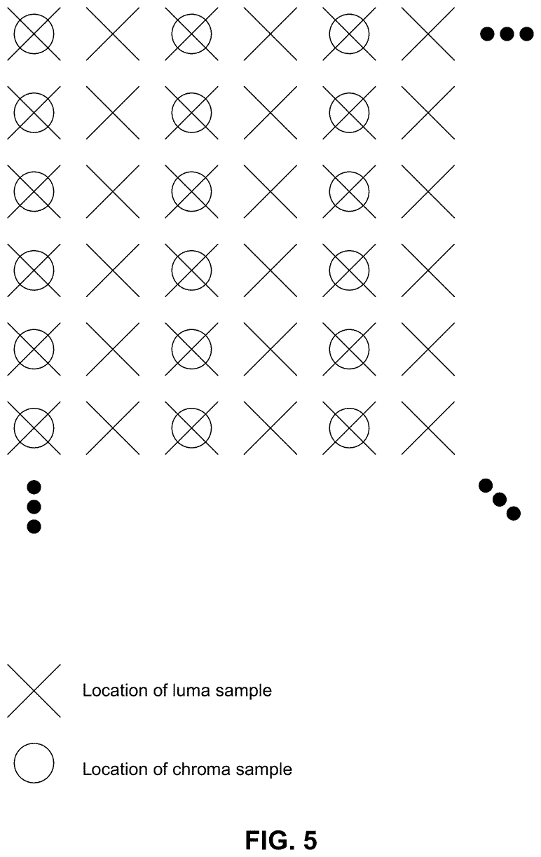

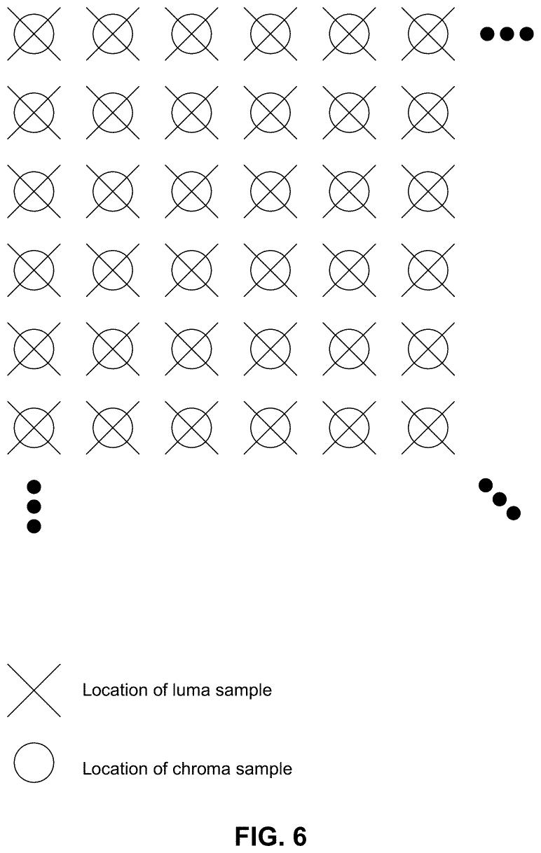

FIG. 5 is a conceptual diagram illustrating example chroma sample locations for a 4:2:2 chroma format. As shown in the example of FIG. 5, when a picture is encoded using the 4:2:2 chroma format, there is a chroma sample in each row of luma sample locations and in alternating columns of luma sample locations. FIG. 6 is a conceptual diagram illustrating example chroma sample locations for a 4:4:4 chroma format. As shown in the example of FIG. 6, when a picture is encoded using the 4:4:4 chroma format there is a chroma sample at each luma sample location. The luma samples that share the same positions at chroma samples in the 4:2:2 and 4:4:4 chroma formats are referred to as the collocated luma samples of the chroma samples.

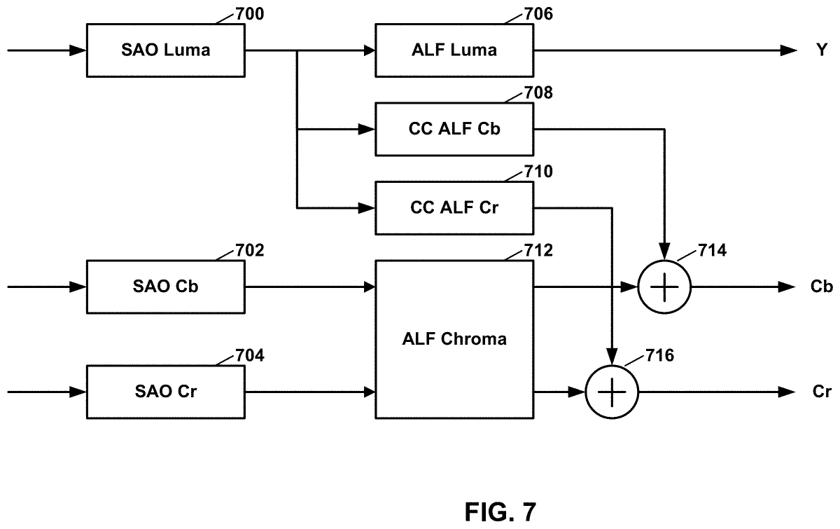

FIG. 7 is a conceptual diagram illustrating cross-component adaptive loop filtering in JVET-O0636. As shown in the example of FIG. 7, a video coder (e.g., video encoder 200 or video decoder 300) may apply Sample Adaptive Offset (SAO) filters 700, 702, 704 to luma, Cb, and Cr samples of a picture, respectively. The video coder may apply an ALF filter 706 to the SAO-filtered luma samples (indicated in FIG. 7 as “Y”) and may apply ALF filter 708, 710 to the SAO-filtered Cb and Cr samples. In some examples of this disclosure, application of the SAO filters is skipped.

To apply an ALF filter, the video coder may multiply sample values within a filter pattern by filter coefficients specified for locations within the filter pattern and sum the resulting values to obtain a filtered value. A video coder may select the filter pattern based on various factors, such as activity along horizontal or vertical directions, a position of a sample within a picture or slice, and/or other factors.

To implement CC-ALF, the video coder may determine values by applying an ALF filter 712 to luma samples corresponding to a Cb sample of the picture. The video coder may add (714) the value to the ALF-filtered version of the Cb sample to determine a modified Cb sample (indicated in FIG. 4 as “Cb”). Similarly, the video coder may determine values by applying an ALF filter to luma samples corresponding to a Cr sample of the picture. The video coder may add (716) the value to the ALF-filtered version of the Cr sample to determine a modified Cr sample (indicated in FIG. 4 as “Cr”). The video coder may store Y, Cb, and Cr in a decoded picture buffer for use in intra or inter prediction of other blocks of video data and/or for display.

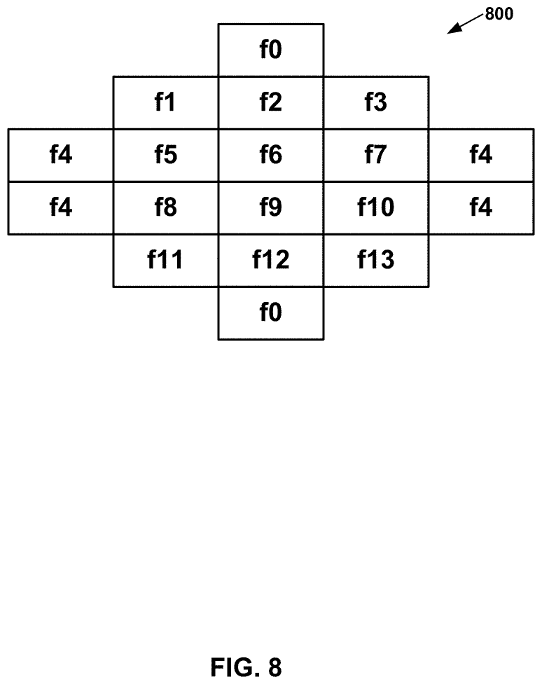

JVET-O0636 indicates that CC-ALF operates by applying a linear, diamond shaped filter (FIG. 8) to the luma channel for each chroma component. In other words, FIG. 8 is a conceptual diagram illustrating a filter 800 used in JVET-O0636. In the example of FIG. 8, the values f0 through f13 correspond to filter coefficients applied to luma samples at corresponding locations. The locations in filter 800 having weights f6 and are applied to luma samples that are immediately above and below a position of a chroma sample being modified.

JVET-O0636 assumes that the video coder applies CC-ALF at a chroma sample location of type 0 when applying the filter. In other words, CC-ALF assumes that there is a suitable luma sample for each chroma component. However, the filter pattern in FIG. 8, where f6 corresponds to the collocated luma sample of a chroma sample, is not suitable for other chroma formats, such as type 1, 2 and 3 for 4:2:0 chroma, 4:2:2 chroma and 4:4:4 chroma formats.

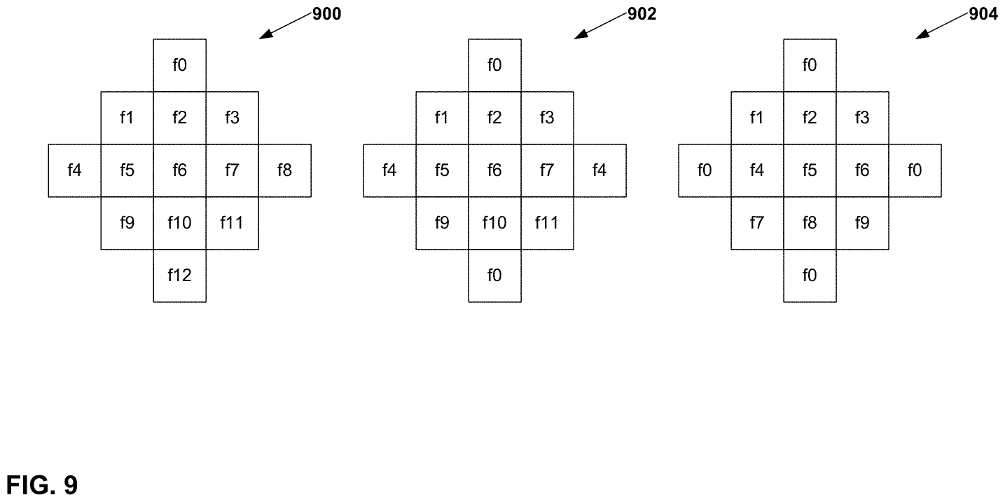

In this disclosure, it is proposed that all chroma formats and types may use the same filter pattern (shape and tap number), such as a diamond pattern (shown in FIG. 9 as an example), where the center coefficient is applied the collocated luma pixel. FIG. 9 is a conceptual diagram illustrating example diamond filter shapes in accordance with one or more techniques of this disclosure. Specifically, FIG. 9 shows a first filter shape 900, a second filter shape 902, and a third filter shape 904. While filter shapes 900, 902, and 904 have the same shape, there are different patterns of filter coefficients within each of filter shapes 900, 902, and 904.

Hence, in some examples where all chroma formats and types use the same filter pattern, the video coder may determine a value (e.g., a value produced by ALF filter 708 or ALF filter 710 of FIG. 7) by applying an ALF to luma samples corresponding to a chroma sample of a current picture. In such examples, the luma samples corresponding to the chroma sample are within a filter pattern that is the same for all chroma formats and types of chroma samples. Furthermore, in such examples, a center coefficient of the filter pattern is applied to a collocated luma sample of the chroma sample. The video coder may also be configured to add the value to the chroma sample to determine a modified chroma value (e.g., as shown in addition operation 714 or 716 of FIG. 7).

In some examples of this disclosure, different chroma formats and/or chroma types may use different filter patterns. In some examples, the filter pattern (filter shape and tap number) may be signaled at a sequence/picture/sub-picture level. For example, the filter pattern may be signaled in a sequence parameter set, picture parameter set, slice, or other syntax structure. In some examples, a video coder (e.g., video encoder 200 or video decoder 300) may infer the filter pattern according to a chroma format and/or a chroma type.

For example, the filter pattern in FIG. 5 may be applied to type 0, 1 and 3 chroma samples in a 4:2:0 chroma format. A diamond filter pattern (where the center is the collocated luma pixel), as shown in FIG. 9 as an example, may be applied to type 2 chroma samples in 4:2:0 chroma format, 4:2:2 chroma format and 4:4:4 chroma format.

In another example, the relative position between the chroma sample to be filtered and the center position of luma samples used for filtering may be signaled in bitstream. The filter shape and tap number may be dependent on the chroma format and relative position between luma and chroma samples.

Hence, in accordance with the techniques of this disclosure, a video coder (e.g., video encoder 200 or video decoder 300) may determine a filter pattern from a plurality of filter patterns. The video coder may also be configured to determine a value (e.g., a value produced by ALF filter 708 or ALF filter 710 of FIG. 7) by applying an ALF to luma samples corresponding to a chroma sample of a current picture, the luma samples corresponding to the chroma sample being within the determined filter pattern. Additionally, the video coder may add the value to the chroma sample to determine a modified chroma value (e.g., as shown in addition operation 714 or 716 of FIG. 7). In some examples, the video coder may determine the filter pattern based on data signaled in at least one of: a sequence level, a picture level, or a sub-picture level. In some examples, the video coder may determine the filter pattern based at least in part on a chroma format of the current picture. In some examples, the video coder may determine the filter pattern based at least in part on a chroma type of the chroma sample. In some examples, the video coder may determine the filter pattern based at least in part of a relative position between the luma samples and the chroma sample.

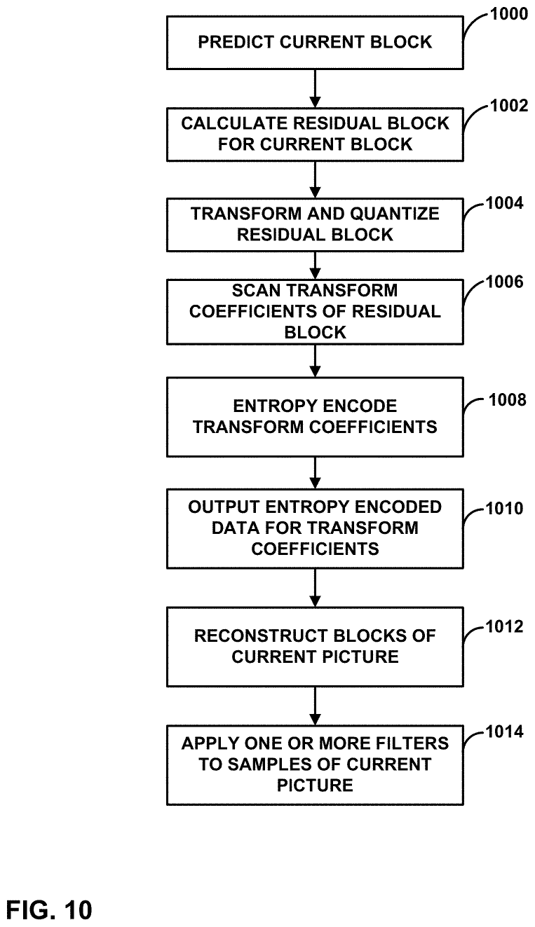

FIG. 10 is a flowchart illustrating an example method for encoding a current block of a current picture of video data in accordance with one or more techniques of this disclosure. The current block may comprise a current CU. Although described with respect to video encoder 200 (FIGS. 1 and 2), it should be understood that other devices may be configured to perform a method similar to that of FIG. 10.

In this example, video encoder 200 initially predicts the current block (1000). For example, video encoder 200 may form a prediction block for the current block. Video encoder 200 may then calculate a residual block for the current block (1002). To calculate the residual block, video encoder 200 may calculate a difference between the original, unencoded block and the prediction block for the current block. Video encoder 200 may then transform and quantize transform coefficients of the residual block (1004). Next, video encoder 200 may scan the quantized transform coefficients of the residual block (1006). During the scan, or following the scan, video encoder 200 may entropy encode the transform coefficients (1008). For example, video encoder 200 may encode the transform coefficients using CAVLC or CABAC. Video encoder 200 may then output the entropy encoded data of the block (1010).

Furthermore, video encoder 200 may reconstruct blocks of the current picture (1012). Additionally, video encoder 200 (e.g., filter unit 216 of video encoder 200) may apply one or more filters to samples of the current picture (1014). As part of applying the one or more filters, video encoder 200 may apply the CC-ALF techniques of this disclosure. Thus, in some examples, video encoder 200 may use a filter pattern that is the same for all chroma formats and types of chroma samples, where a center coefficient of the filter pattern is applied to a collocated luma sample of the chroma sample. In some examples, video encoder 200 may apply the CC-ALF differently when the current picture has different chroma formats. Video encoder 200 may subsequently use the filtered samples of the current picture for intra or inter prediction of other blocks.

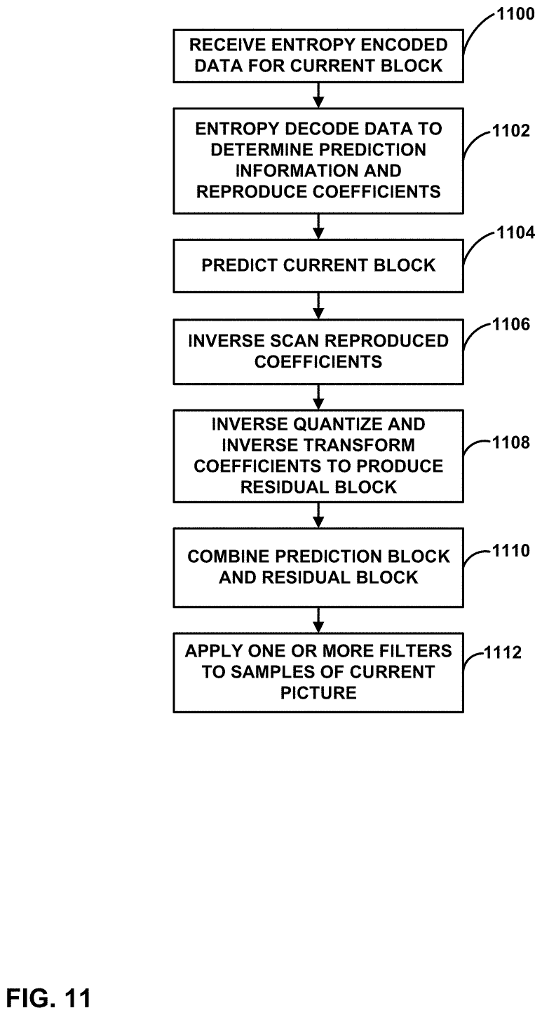

FIG. 11 is a flowchart illustrating an example method for decoding a current block of a current picture of video data in accordance with one or more techniques of this disclosure. The current block may comprise a current CU. Although described with respect to video decoder 300 (FIGS. 1 and 3), it should be understood that other devices may be configured to perform a method similar to that of FIG. 11.

Video decoder 300 may receive entropy encoded data for the current block, such as entropy encoded prediction information and entropy encoded data for transform coefficients of a residual block corresponding to the current block (1100). Video decoder 300 may entropy decode the entropy encoded data to determine prediction information for the current block and to reproduce transform coefficients of the residual block (1102). Video decoder 300 may predict the current block (1104), e.g., using an intra- or inter-prediction mode as indicated by the prediction information for the current block, to calculate a prediction block for the current block. Video decoder 300 may then inverse scan the reproduced transform coefficients (1106), to create a block of quantized transform coefficients. Video decoder 300 may then inverse quantize and inverse transform the transform coefficients to produce a residual block (1108). Video decoder 300 may ultimately decode the current block by combining the prediction block and the residual block (1110).

Additionally, video decoder 300 (e.g., filter unit 312 of video decoder 300) may apply one or more filters to samples of the current picture (1112). As part of applying the one or more filters, video decoder 300 may apply the CC-ALF techniques of this disclosure. Thus, in some examples, video decoder 300 may use the same filter pattern that is the same for all chroma formats and types of chroma samples, where a center coefficient of the filter pattern is applied to a collocated luma sample of the chroma sample. In some examples, video decoder 300 may apply the CC-ALF differently when the current picture has different chroma formats.

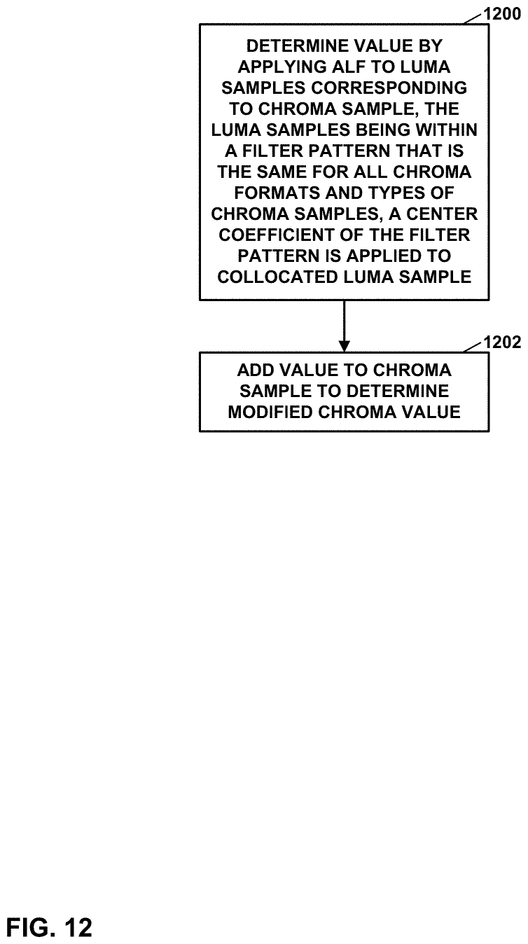

FIG. 12 is a flowchart illustrating an example method for coding a current block of video data, in accordance with one or more techniques of this disclosure. In the example of FIG. 12, a video coder (e.g., video encoder 200 or video decoder 300) may determine a value by applying an ALF to luma samples corresponding to a chroma sample of a current picture (1200). The luma samples corresponding to the chroma sample are within a filter pattern that is the same for all chroma formats and types of chroma samples. A center coefficient of the filter pattern is applied to a collocated luma sample of the chroma sample.

In some examples, even though the video coder uses the same filter pattern for all chroma formats and types of chroma samples, the video coder may determine the filter pattern from a plurality of filter patterns. In some such examples, the video coder may determine the filter pattern based on data signaled in at least one of: a sequence level, a picture level, or a sub-picture level.

In some examples, the video coder may determine a reconstructed chroma sample by adding a prediction sample to a corresponding residual sample (e.g., by reconstruction unit 214 of video encoder 200 (FIG. 2) or reconstruction unit 310 of video decoder 300 (FIG. 3)). Additionally, the video coder may apply an ALF chroma filter a set of chroma samples that includes the chroma sample to determine a modified version of the reconstructed chroma sample (e.g., as shown in 712 of FIG. 7). The set of chroma samples may have a diamond patter, e.g., as shown in the example of FIG. 9. Adding the value to the chroma sample in step 1200 of FIG. 12 may include adding the value to the modified version of the reconstructed chroma sample to determine the modified chroma value ((e.g., as shown in 714 or 716 of FIG. 7).

Additionally, the video coder may add the value to the chroma sample to determine a modified chroma value (1202). In examples where the video coder is a video encoder, such as video encoder 200, the video encoder may use the modified chroma value for inter prediction or intra prediction of other blocks of video data. In examples where the video coder is a video decoder, such as video decoder 300, the video decoder may generate an RGB sample based on the modified chroma value for display and output the RGB sample for display. In some examples where the video coder is a video decoder, such as video decoder 300, the video decoder may use the modified chroma value for inter prediction or intra prediction of other blocks of video data, and/or perform other actions with respect to the modified chroma value.

In some examples where the video coder is a video encoder (e.g., video encoder 200), the video encoder may use the modified chroma value in an inter prediction process to encode a subsequent block of the video data. In some examples where the video coder is a video decoder (e.g., video decoder 300), the video decoder may generate an RGB sample based on the modified chroma value and output the RGB sample for display.

The following is a non-limiting list of numbered examples that are in accordance with one or more techniques of this disclosure.

Example 1. A method of coding video data, the method comprising: determining a filter pattern from a plurality of filter patterns; determining a value by applying an adaptive loop filter (ALF) to luma samples corresponding to a chroma sample of a current picture, the luma samples being within the determined filter pattern; and adding the value to the chroma sample to determine a modified chroma value.

Example 2. The method of example 1, wherein determining the filter pattern comprises determining the filter pattern based on data signaled in at least one of: a sequence level, a picture level, or a sub-picture level.

Example 3. The method of any of examples 1-2, wherein determining the filter pattern comprises determining the filter pattern based at least in part on a chroma format of the current picture.

Example 4. The method or any of examples 1-3, wherein determining the filter pattern comprises determining the filter pattern based at least in part on a chroma type of the chroma sample.

Example 5. The method of any of examples 1-4, wherein determining the filter pattern comprises determining the filter pattern based at least in part of a relative position between the luma samples and the chroma sample.

Example 6. A method of coding video data, the method comprising: determining a value by applying an adaptive loop filter (ALF) to luma samples corresponding to a chroma sample of a current picture, the luma samples being within a filter pattern that is the same for all chroma formats and types of chroma samples, wherein a center coefficient of the filter pattern is applied to a collocated luma sample; and adding the value to the chroma sample to determine a modified chroma value.

Example 7. The method of any of examples 1-6, wherein coding comprises decoding.

Example 8. The method of any of examples 1-7, wherein coding comprises encoding.

Example 9. A device for coding video data, the device comprising one or more means for performing the method of any of examples 1-8.

Example 10. The device of example 9, wherein the one or more means comprise one or more processors implemented in circuitry.

Example 11. The device of any of examples 9 and 10, further comprising a memory to store the video data.

Example 12. The device of any of examples 9-11, further comprising a display configured to display decoded video data.

Example 13. The device of any of examples 9-12, wherein the device comprises one or more of a camera, a computer, a mobile device, a broadcast receiver device, or a set-top box.

Example 14. The device of any of examples 9-13, wherein the device comprises a video decoder.

Example 15. The device of any of examples 9-14, wherein the device comprises a video encoder.

Example 16. A computer-readable storage medium having stored thereon instructions that, when executed, cause one or more processors to perform the method of any of examples 1-8.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

What is claimed is:

1. A method of coding video data, the method comprising:
determining a value by applying an adaptive loop filter (ALF) to luma samples corresponding to a chroma sample of a current picture, the luma samples corresponding to the chroma sample being within a filter pattern that is the same for all chroma formats and types of chroma samples, wherein a center coefficient of the filter pattern is applied to a collocated luma sample of the chroma sample; and
adding the value to the chroma sample to determine a modified chroma value.

2. The method of claim 1, further comprising determining the filter pattern from a plurality of filter patterns.

3. The method of claim 2, wherein determining the filter pattern comprises determining the filter pattern based on data signaled in at least one of: a sequence level, a picture level, or a sub-picture level.

4. The method of claim 1, further comprising:
determining a reconstructed chroma sample by adding a prediction sample to a corresponding residual sample; and
applying an ALF chroma filter to a set of chroma samples that includes the chroma sample to determine a modified version of the reconstructed chroma sample,
wherein adding the value to the chroma sample comprises adding the value to the modified version of the reconstructed chroma sample to determine the modified chroma value.

5. The method of claim 1, wherein coding comprises decoding.

6. The method of claim 5, further comprising:
generating an RGB sample based on the modified chroma value; and
outputting the RGB sample for display.

7. The method of claim 1, wherein coding comprises encoding.

8. The method of claim 7, wherein the method further comprises using the modified chroma value in an inter prediction process to encode a subsequent block of the video data.

9. A device for coding video data, the device comprising:
a memory to configured to store the video data; and
one or more processors implemented in circuitry, the one or more processors configured to:
determine a value by applying an adaptive loop filter (ALF) to luma samples corresponding to a chroma sample of a current picture, the luma samples being within a filter pattern that is the same for all chroma formats and types of chroma samples, wherein a center coefficient of the filter pattern is applied to a collocated luma sample of the chroma sample; and
add the value to the chroma sample to determine a modified chroma value.

10. The device of claim 9, wherein the one or more processors are further configured to determine the filter pattern from a plurality of filter patterns.

11. The device of claim 10, wherein the one or more processors are configured such that, as part of determining the filter pattern, the one or more processors determine the filter pattern based on data signaled in at least one of: a sequence level, a picture level, or a sub-picture level.

12. The device of claim 9, wherein:
the one or more processors are further configured to:
determine a reconstructed chroma sample by adding a prediction sample to a corresponding residual sample; and
apply an ALF chroma filter to a set of chroma samples that includes the chroma sample to determine a modified version of the reconstructed chroma sample, and
wherein the one or more processors are configured such that, as part of adding the value to the chroma sample, the one or more processors add the value to the modified version of the reconstructed chroma sample to determine the modified chroma value.

13. The device of claim 9, wherein coding comprises decoding.

14. The device of claim 13, wherein the one or more processors are further configured to:
generate an RGB sample based on the modified chroma value; and
output the RGB sample for display.

15. The device of claim 9, wherein coding comprises encoding.

16. The device of claim 15, wherein the one or more processors are further configured to use the modified chroma value in an inter prediction process to encode a subsequent block of the video data.

17. The device of claim 9, wherein the device comprises one or more of a camera, a computer, a mobile device, a broadcast receiver device, or a set-top box.

18. A device for coding video data, the device comprising:
means for determining a value by applying an adaptive loop filter (ALF) to luma samples corresponding to a chroma sample of a current picture, the luma samples being within a filter pattern that is the same for all chroma formats and types of chroma samples, wherein a center coefficient of the filter pattern is applied to a collocated luma sample of the chroma sample; and
means for adding the value to the chroma sample to determine a modified chroma value.

19. The device of claim 18, further comprising means for determining the filter pattern from a plurality of filter patterns.

20. A computer-readable storage medium having stored thereon instructions that, when executed, cause one or more processors to:
determine a value by applying an adaptive loop filter (ALF) to luma samples corresponding to a chroma sample of a current picture, the luma samples being within a filter pattern that is the same for all chroma formats and types of chroma samples, wherein a center coefficient of the filter pattern is applied to a collocated luma sample of the chroma sample; and
add the value to the chroma sample to determine a modified chroma value.
